(19) United States
(12) Patent Application Publication
(10) Pub. No.: US 2026/0003373 A1
(43) Pub. Date: Jan. 1, 2026

(54) COLLABORATIVE ROBOT SYSTEM

(71) Applicant: NACHI-FUJIKOSHI CORP., Tokyo (JP)

(72) Inventor: Tatsuro FUJISAWA, Toyama (JP)

(73) Assignee: NACHI-FUJIKOSHI CORP., Tokyo (JP)

(21) Appl. No.: 19/242,978

(22) Filed: Jun. 19, 2025

(30) Foreign Application Priority Data
Jun. 28, 2024 (JP) 2024-105178

(51) Int. Cl. G05D 1/693; G05D 1/241

(52) U.S. Cl. CPC G05D 1/693; G05D 1/241

(57) ABSTRACT

A collaborative robot system according to the present invention includes a retreat controller including circuitry that causes multiple robots to perform a retreat operation, and the retreat controller, during a standby mode, when an external force is applied to one robot, causes the robot to retreat and also causes another robot adjacent to the retreated robot to perform a separation operation in a direction opposite to a direction of a movement of the retreated robot.

### CROSS-REFERENCE TO RELATED APPLICATION

This application is based upon and claims the benefit of priority from the prior Japanese Patent Application No. 2024-105178, filed on Jun. 28, 2024, the entire contents of which are incorporated herein by reference.

### BACKGROUND OF THE INVENTION

### Field of the Invention

The present invention relates to a collaborative robot system engineered with safety features.

### Description of the Related Arts

Industrial robots that share workspaces with humans, commonly known as collaborative robots, require safety measures. As part of the safety standards for collaborative robots, ISO 10218-1 stipulates multiple requirements for collaborative operation. To comply with the requirements, collaborative robots may be equipped with functions to limit the power (torque) and force exerted by the robots, and if the limit is exceeded, to stop the robot (often referred to as a collision detection function or a collision stop function).

Additionally, collaborative robots may be equipped with a retreat function in addition to the collision detection function. The retreat function is a feature that detects when an operator pushes the robot arm after the robot has stopped and subsequently moves the arm to a retracted position.

Patent Document 1 (U.S. Pat. No. 6,881,525) describes a robot system that enables multiple robots to perform cooperative operations using a single control device. In this robot system, when an irregular state is detected in at least one robot (such as when an abnormal reactive force is detected), the affected robot performs a recovery operation to address the irregular state. At this time, the robot system may allow the other robot to continue the operation, have both robots coordinate the recovery operation, or have both robots operate in synchronization.

Patent Document 2 (U.S. Pat. No. 7,260,727) discloses a numerical control system for controlling a collaborative robot equipped with a retreat function (retreat mode function). This numerical control system allows an operator to move the robot arm by pushing the same, thereby enabling the operator to retreat safely.

### SUMMARY OF THE INVENTION

In order to solve the above-mentioned problems, a representative configuration of the collaborative robot system according to the present invention includes: a plurality of robots equipped with an external force sensor; a collision detector including circuitry that detects a collision of at least one robot among a plurality of robots with an object using an output from the external force sensor; an operation determinator including circuitry that switches an operation mode of the robot from an autonomous operation mode to a standby mode based on the detection from the collision detector; and a retreat controller including circuitry that executes a retreat operation for the plurality of robots, in which the retreat controller, in the standby mode, when one robot receives an external force, controls the robot to retreat and controls the other robot located in proximity to the retreated robot in a direction opposite to a movement of the retreated robot, thereby performing a separation operation.

In order to solve the above-mentioned problems, another representative configuration of the collaborative robot system according to the present invention includes: a plurality of robots equipped with an external force sensor; a collision detector including circuitry that detects a collision of at least one robot among a plurality of robots with an object using an output from the external force sensor; an operation determinator including circuitry that switches an operation mode of the robot from an autonomous operation mode to a standby mode based on the detection from the collision detector; and a retreat controller including circuitry that causes the plurality of robots to perform a retreat operation, in which the retreat controller, in the standby mode, when one robot receives an external force, retreats the robot and performs a cooperative retreat operation by moving the other robot, which is in a cooperative operation with the retreated robot, to maintain a positional relationship with the retreated robot.

In order to solve the above-mentioned problems, yet another representative configuration of the collaborative robot system according to the present invention includes: a plurality of robots equipped with an external force sensor; a collision detector including circuitry that detects a collision of at least one robot among a plurality of robots with an object using an output from the external force sensor; an operation determinator including circuitry that switches an operation mode of the robot from an autonomous operation mode to a standby mode based on the detection from the collision detector; and a retreat controller including circuitry that executes a retreat operation for the plurality of robots, in which when the retreat controller, in the standby mode, when one robot receives an external force, if a program that is being executed during the collision is a non-cooperative operation, retreats the robot while performing a separation operation by moving the other robot in proximity to the retreated robot in a direction opposite to a movement of the retreated robot and if a program that is being executed during the collision is a cooperative operation, retreats the robot while performing a cooperative retreat operation by moving the other robot, which is in a cooperative operation with the retreated robot, to maintain a positional relationship with the retreated robot.

### BRIEF DESCRIPTION OF THE DRAWINGS

FIG. 1 is a block diagram showing the functions of the collaborative robot system according to an embodiment of the present invention.

FIG. 2 is a flowchart showing the operation of the collaborative robot system in a standby mode as shown in FIG. 1.

FIG. 3A shows a state where the gap between the end effectors and the end effectors of the robots is narrow.

FIG. 3B shows a state where the gap between the end effectors have been retracted in a mirror-retreatment.

FIG. 4 is a diagram explaining the retreat function of one of the two robots as shown in FIG. 1.

FIG. 5A is a diagram explaining the cooperative retreat operation of two robots in FIG. 1.

FIG. 5B a diagram explaining the operation when an external force is applied.

FIG. 6 is a flowchart showing the operation of the collaborative robot system in the standby mode, according to another embodiment of the invention in FIG. 1.

### DESCRIPTION OF THE EMBODIMENTS

Preferred embodiments of the present invention will be described in detail below with reference to the accompanying drawings. The dimensions, materials, and other specific numerical values shown in this embodiment are merely examples for the purpose of facilitating understanding of the invention and do not limit the invention unless specifically stated. Furthermore, in this specification and the drawings, elements having substantially the same function and structure will be referred to with the same reference numerals to avoid redundant explanations, and elements not directly related to the invention will be omitted from the illustrations.

In the following explanation, the term “collaborative robot” refers to a robot that is capable of operating within the same space as a human and is equipped with safety features such as a collision detection mechanism and speed limitation function. Additionally, the term “cooperative operation” refers to an operation in which multiple robots work in coordination or synchronization.

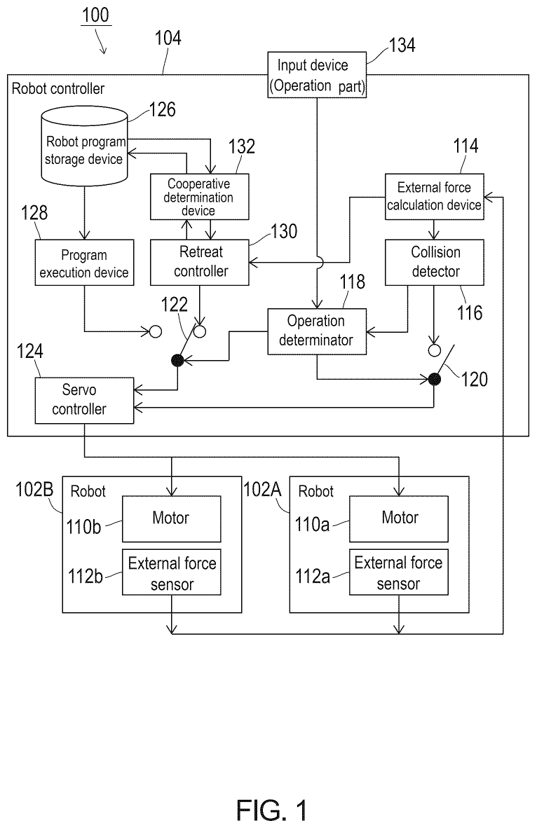

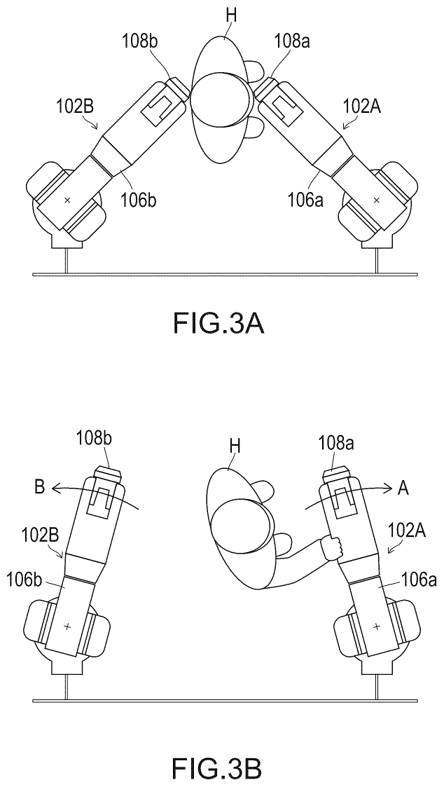

FIG. 1 is a block diagram illustrating the functions of a collaborative robot system 100 according to an embodiment of the present invention. The collaborative robot system 100 is an industrial robot system that shares a workspace with an operator H (see FIG. 3) and is equipped with a plurality of collaborative robots (two robots in this embodiment, hereinafter referred to as the robots 102A and 102B) as well as a robot control device 104.

The robots 102A and 102B are controlled by the robot controller 104, which enables the robots 102A and 102B to operate cooperatively according to a program and to operate independently as needed. Each of the robots 102A and 102B is equipped with arms 106a and 106b and end effectors 108a and 108b mounted at the tips of the respective arms 106a and 106b, as shown, for example, in FIG. 3.

The robots 102A and 102B are also equipped with motors 110a and 110b, which drive the arms 106a and 106b, as well as external force sensors 112a and 112b. The external force sensors 112a and 112b are utilized for feedback during autonomous operation mode (normal operation, in which the robot program is executed). Additionally, the external force sensors 112a and 112b detect external forces applied to the robots 102A and 102B, such as when the operator H collides with the robots 102A and 102B.

The robot controller 104 includes an external force calculator 114, a collision detector 116, an operation determinator 118, switches 120 and 122, a servo controller 124, a robot program storage device 126, a program execution device 128, a retreat controller 130, and a cooperative determinator 132.

In an autonomous operation mode, the robots 102A and 102B are in a state where an operation command value from the program execution device 128 can be output to the servo controller 124 via the switch 122. The program execution device 128 reads a robot program stored in the robot program storage device 126, which governs the operation of the robots 102A and 102B (normal operation), and outputs the corresponding operation command value to the servo controller 124. In this manner, the program execution device 128 facilitates the execution of the autonomous operation mode of the robots 102A and 102B.

The external force calculator 114 receives signals from the external force sensors 112a and 112b. The external force calculator 114 calculates the external force values based on the sensor values output from the external force sensors 112a and 112b and outputs the external force values to the collision detector 116 and the retreat controller 130. The collision detector 116 has circuitry that detects a collision of at least one robot among the robots 102A and 102B with an object, specifically the operator H, when the external force value occurs at an unexpected timing or exceeds a predetermined value, and outputs a collision detection signal to the operation determinator 118.

The operation determinator 118 has circuitry that switches the operation mode of the robots 102A and 102B. More specifically, the operation determinator 118 with circuitry, upon receiving the collision detection signal from the collision detector 116, turns off the switch 120 and outputs a stop command to the servo control device 124. The stop command is an instruction to execute an emergency stop of the autonomous operation mode that is a normal operation mode of the robots 102A and 102B. When the stop command is input from the operation determinator 118, the servo control device 124 outputs operation command values to the motors 110a and 110b of the robots 102A and 102B, thereby executing an emergency stop of the autonomous operation mode of the robots 102A and 102B.

Additionally, upon receiving the collision detection signal from the collision detector 116, the operation determinator 118 with circuitry switches the switch 122 to change the operating mode of the robots 102A and 102B from the autonomous operation mode to the standby mode. In this mode, the connection between the program execution device 128 and the servo control device 124 is severed, and the retreat controller 130 with circuitry is connected to the servo control device 124. In the standby mode, as shown in FIG. 1, the robot 102A and 102B enter a state in which the operation command values from the retreat controller 130 can be output to the servo control device 124 via the switch 122.

In addition, after the operating mode of the robots 102A and 102B has been switched from the autonomous operation mode to the standby mode, the operation determinator 118 can turn on the switch 120 and revert the operating mode back to the autonomous operation mode if an input device (operation part 134) such as an operation button and an external system inputs an automatic operation initiation signal.

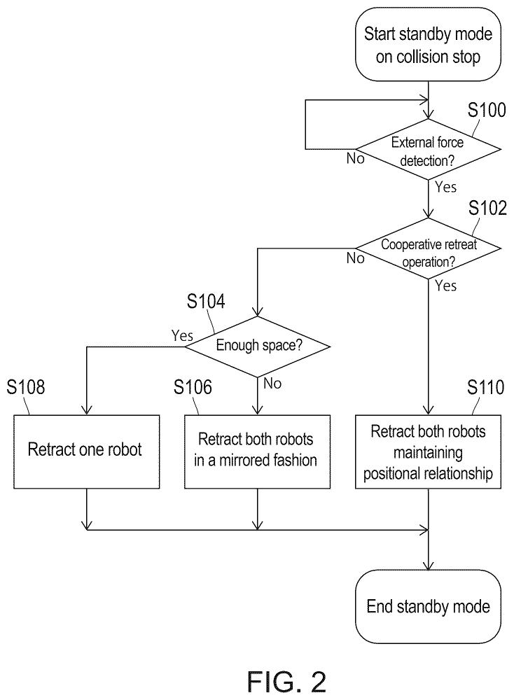

FIG. 2 is a flowchart showing the operation of the collaborative robot system 100 in the standby mode. As described above, the standby mode begins at a state where the collision detector with circuitry 116 detects a collision between the robots 102A and 102B and the operator H, prompting the motion determination device 118 to turn off the switch 120, and trigger an emergency stop of the autonomous operation mode of the robots 102A and 102B.

Firstly, during the standby mode, the retreat controller 130, which has circuitry, determines whether an external force has been applied to one of the robots 102A or 102B (Step S100). At this point, the retreat controller 130 remains on standby, repeatedly executing the process of the Step S100 until an external force value is input from the external force calculation device 114 (No in Step S100).

When the external force value is input from the external force calculation device 114 (Yes in Step S100), the cooperative determination device 132 refers to the robot program stored in the robot program storage device 126 according to an instruction from the retreat controller 130. Then, the cooperative determination device 132 determines whether the command in the robot program executed during the emergency stop was for a cooperative operation (whether the command was recorded as a cooperative operation during teaching) and outputs the cooperative operation determination result to the retreat controller 130.

Next, based on the cooperative operation determination result from the cooperative determination device 132, if the retreat controller 130 determines that one robot subjected to the external force was not in a cooperative operation state, that is, in a non-cooperative operation state (No in Step S102), the retreat controller 130 determines whether there is a sufficient gap between the two robots 102A and 102B (step S104).

FIG. 3A shows a state where the gap between the end effectors 108a and 108b of robots 102A and 102B is narrow. The distance between (respective position of) the end effectors 108a and 108b can be known from the coordinates of the end effectors 108a and 108b at the time of the emergency stop (No in Step S104).

FIG. 3B shows a state where the end effectors 108a and 108b are retracted in a mirrored manner. As shown in FIG. 3B, when an external force is applied to one of the robots 102A and 102B by the operator H, the retreat controller 130 with circuitry, retracts the robots 102A and 102B in a mirrored fashion (Step S106). Specifically, the retreat controller 130 causes the robot 102A to retreat in the direction of the external force indicated by arrow A, while simultaneously performing a separation operation to move the other robot 102B adjacent to the robot 102A in an opposite direction indicated by arrow B.

As a result, the gap between the adjacent robots 102A and 102B increases, allowing the operator H to escape safely. Therefore, according to the collaborative robot system 100, the robots 102A and 102B cooperate to perform a retreat operation, thereby improving safety.

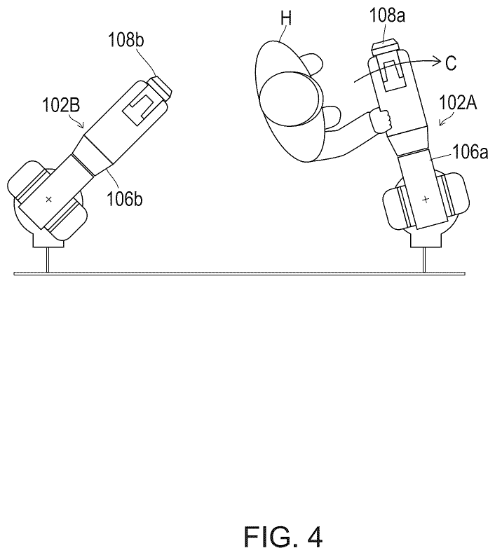

FIG. 4 illustrates the retreat function of one robot 102A among the two robots in FIG. 1. When the gap between the end effectors 108a and 108b is wide during an emergency stop (Yes in Step S104), as shown in FIG. 4, if the operator H applies an external force to one of the robots, specifically robot 102A, among the robot 102A and 102B, the retreat controller 130 with circuitry, retracts only the robot 102A in the direction of the external force, as indicated by arrow C (Step S108). In this manner, when the operator H can escape by retracting only one robot, retracting only the robot 102A to which the external force has been applied ensures that the operator H can safely escape, thereby improving safety.

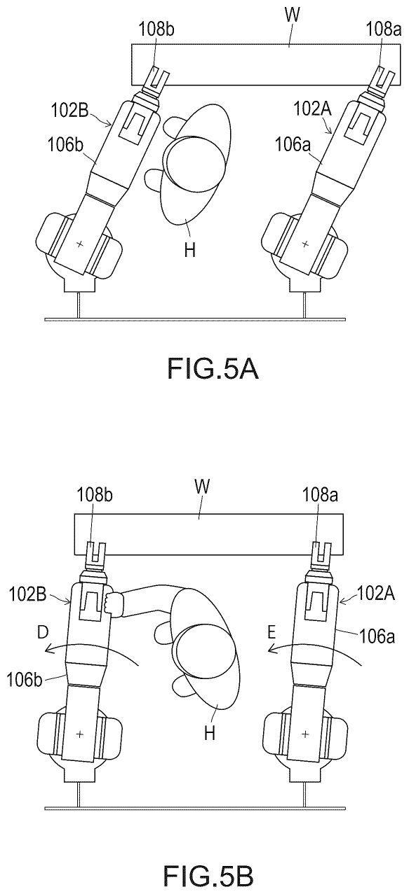

Furthermore, in Step S102 shown in FIG. 2, the retreat controller 130, based on the result of the cooperative operation determination from the cooperative determination device 132, performs the processing in Step S110 when the retreat controller 130 determines that the robot, to which the external force is applied, is engaged in a cooperative operation (Yes). In Step S110, the retreat controller 130 performs a cooperative retreat operation to retreat the robots 102A and 102B while maintaining the positional relationship of two robots 102A and 102B, (See FIG. 5).

FIG. 5A explains the cooperative retreat motion performed by two robots 102A and 102B in FIG. 1. FIG. 5A shows a state where the adjacent robots 102A and 102B are performing a cooperative motion as gripping the workpiece W with the end effectors 108a and 108b, resulting in the operator H being surrounded by the arms 106a and 106b of the robots 102A, 102B, and the workpiece W.

FIG. 5B explains the operation when an external force is applied. As shown in FIG. 5B, when the operator H applies an external force to one of the robots, specifically robot 102B, among the robot 102A and 102B, the retreat controller 130 with circuitry retracts the robot 102B in the direction of the external force, as indicated by arrow D, while simultaneously performing the cooperative retreat operation to move the other robot 102A, which was engaged in the cooperative operation, in the direction indicated by arrow E to maintain the positional relationship.

Thus, in the collaborative robot system 100, even if the adjacent robots 102A and 102B are cooperating to grip the workpiece W, the workpiece W will not be dropped and damaged, nor will the dropped workpiece W collide with the operator H. Therefore, the safety of the operator H attempting to escape is enhanced.

Moreover, after performing the cooperative retreat motion, both arms 106a and 106b of the robots 102A and 102B ensure an appropriate gap without colliding with the operator H. As a result, the safety of the operator H is not compromised. In other words, according to the collaborative robot system 100, by performing a cooperative retreat operation, it is possible not only to ensure the safety of the operator H but also to prevent the workpiece W from falling.

Furthermore, after moving the robots 102A and 102B in the directions shown by arrows D and E in FIG. 5B, the retreat controller 130 with circuitry may also perform a cooperative retreat operation by lifting the arms 106a and 106b. By performing such a cooperative retreat motion, even if a wall is positioned behind the operator H, the operator H can be safely and reliably assisted in escaping.

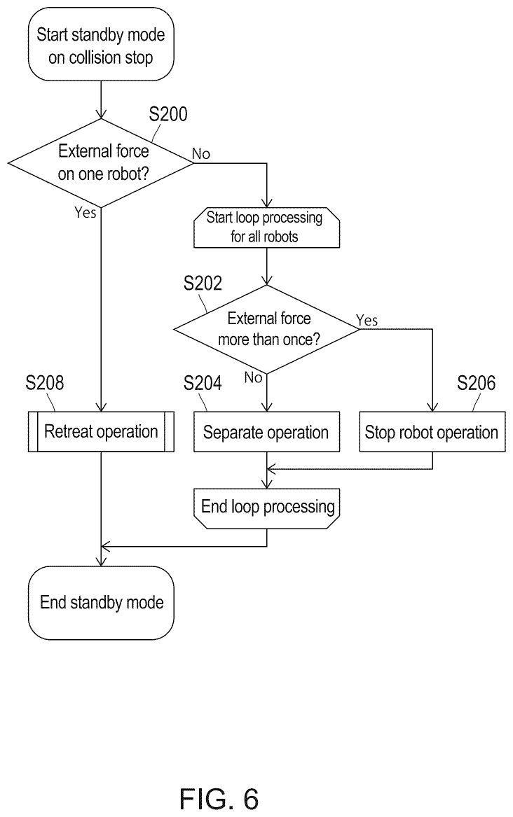

FIG. 6 shows a flowchart of the operation in the standby mode of another embodiment of the collaborative robot system 100 shown in FIG. 1. First, during the standby mode, the retreat controller 130 with circuitry determines whether an external force was applied to one robot or more robots (step S200). Here, the external force calculation device 114 outputs two external force values to the retreat controller 130 when sensor values from both external force sensors 112a and 112b of the robots 102A and 102B are input, and if sensor values are input from only one of the external force sensors 112a or 112b, a single external force value is input to the retreat controller 130.

In Step S200, if the retreat controller 130 with circuitry determines that the external force has been applied to one robot (Yes), the retreat controller 130 proceeds to perform the retreat operation (Step S208). In the retreat operation of the Step S208, the retreat controller 130 executes the standby mode Steps S100 to S110 shown in FIG. 2 to perform a separation operation as shown in FIG. 3, to retract only robot 102A as shown in FIG. 4, or to perform the cooperative retreat operation shown in FIG. 5.

In Step S200, if the external force calculation device 114 outputs two external force values, the retreat controller 130 determines that the external force has been applied to both robots 102A and 102B (No in Step S200) and proceeds to loop processing starting from Step S202. In Step S202, the retreat controller 130 determines whether the external force has been applied more than once to each of two robots 102A and 102B.

In Step S202, if the external force has been applied only once to each of the robot 102A and 102B (No), the retreat controller 130 performs a separation operation by retreating the robots 102A and 102B in the direction to increase the gap therebetween (Step S204). This ensures the operator can escape safely and improves safety.

On the other hand, in Step S202, if the external force has been applied more than once to each robot 102A and 102B within a predetermined time (Yes), the retreat controller 130 stops the robots 102A and 102B (step S206). The “stopping” in step S206 means maintaining the stopped state without performing either the retreat operation or the separation operation, while the robots are already stopped in the standby mode. “External force applied more than once within a predetermined time” refers to what is commonly known as a double-tap, triple-tap, etc. By allowing the operator to apply an external force to the robots 102A and 102B to issue a stop command, an intent of the operator can be conveyed to the retreat controller 130, thereby enabling more situation-appropriate actions to be commanded and further improving safety.

In the above example, a single tap illustrates the retreat operation (S208) or the separation operation (S204), while a double tap illustrates the stop operation of the robot (S206). However, the invention is not limited to this and can be set such that the stop operation of the robot is commanded by a single tap and the retreat operation is commanded by a double tap. By changing the behavior of stopping or retreating based on the number of times an external force is applied to a single robot within a predetermined time, the operator can appropriately command the robot. Furthermore, in addition to the retreat operation, the stop command also becomes possible, thereby further improving safety.

The above has described preferred embodiments of the present invention with reference to the attached drawings. However, it is clear that the invention is not limited to these examples. A person skilled in the art will readily be able to think of various modifications or changes within the scope of the claims, and these modifications and changes are naturally understood to belong to the technical scope of the present invention.

### INDUSTRIAL APPLICABILITY

The present invention can be applied to collaborative robot systems equipped with safety functions.

What is claimed:

1: A collaborative robot system comprising:
a plurality of robots equipped with an external force sensor;
a collision detector including circuitry that detects a collision of at least one robot among a plurality of robots with an object using an output from the external force sensor;
an operation determinator including circuitry that switches an operation mode of the robot from an autonomous operation mode to a standby mode based on the detection from the collision detector; and
a retreat controller including circuitry that executes a retreat operation for the plurality of robots,
wherein the retreat controller, in the standby mode, when one robot receives an external force, controls the robot to retreat and controls the other robot located in proximity to the retreated robot to move in a direction opposite to a movement direction of the retreat robot, thereby performing a separation operation.

2: A collaborative robot system comprising:
a plurality of robots equipped with an external force sensor;
a collision detector including circuitry that detects a collision of at least one robot among a plurality of robots with an object using an output from the external force sensor;
an operation determinator including circuitry that switches an operation mode of the robot from an autonomous operation mode to a standby mode based on the detection from the collision detector; and
a retreat controller including circuitry that causes the plurality of robots to perform a retreat operation,
wherein the retreat controller, in the standby mode, when one robot receives an external force, retreats the robot and performs a cooperative retreat operation by moving the other robot, which is in a cooperative operation with the retreated robot, to maintain a positional relationship with the retreated robot.

3: A collaborative robot system comprising:
a plurality of robots equipped with an external force sensor;
a collision detector including circuitry that detects a collision of at least one robot among a plurality of robots with an object using an output from the external force sensor;
an operation determinator including circuitry that switches an operation mode of the robot from an autonomous operation mode to a standby mode based on the detection from the collision detector; and
a retreat controller including circuitry that executes a retreat operation for the plurality of robots,
wherein the retreat controller, in the standby mode, when one robot receives an external force, if a program that is being executed during the collision is a non-cooperative operation, retreats the robot while performing a separation operation by moving the other robot in proximity to the retreated robot in an opposite direction of a movement of the retreated robot and if a program that is being executed during the collision is a cooperative operation, retreats the robot while performing a cooperative retreat operation by moving the other robot, which is in a cooperative operation with the retreated robot, to maintain a positional relationship with the retreated robot.

4: The collaborative robot system according to claim 1,
wherein the retreat controller, when each of two adjacent robots receive an external force once, performs a separation operation to move the two robots, to which the external force is applied, in directions that increase the distance between the two robots.

5: The collaborative robot system according to claim 3,
wherein the retreat controller, when each of two adjacent robots receive an external force once, performs a separation operation to retract the two robots in directions that increase the distance between the two robots.

6: The collaborative robot system according to claim 1,
wherein the retreat controller, when a single robot receives multiple external forces within a predetermined time, maintains a stop state of the robot.

7: The collaborative robot system according to claim 2,
wherein the retreat controller, when a single robot receives multiple external forces within a predetermined time, maintains a stop state of the robot.

8: The collaborative robot system according to claim 3,
wherein the retreat controller, when a single robot receives multiple external forces within a predetermined time, maintains a stop state of the robot.

9: The collaborative robot system according to claim 1,
wherein the retreat controller, when a single robot receives multiple external forces within a predetermined time, performs the separation operation.

10: The collaborative robot system according to claim 3,
wherein the retreat controller, when a single robot receives multiple external forces within a predetermined time, performs the separation operation.

11: The collaborative robot system according to claim 1,
wherein the retreat controller, when a single robot receives multiple external forces within a predetermined time, performs the cooperation retreat operation.

12: The retreat controller according to claim 3,
wherein the retreat controller, when one robot receives multiple external forces within a predetermined time, performs the cooperative retreat operation.
